(19) United States
(12) Patent Application Publication
(10) Pub. No.: US 2025/0297945 A1
(43) Pub. Date: Sep. 25, 2025

(54) EMBEDDED SENSOR RESPONSE LINEARIZATION METHOD

(71) Applicant: APPLIED MATERIALS, INC., Santa Clara, CA (US)

(72) Inventors: USMAN CHOWDHURY, Santa Clara, CA (US); WILLIAM J. DURAND, San Francisco, CA (US); MARIO DANIEL SANCHEZ, Santa Clara, CA (US); ABDULLAH ZAFAR, Santa Clara, CA (US); KASTURI SARANG, San Jose, CA (US); AMIR BAYATI, San Jose, CA (US); AUNG TOE, Newton, MA (US); JOSHUA JONES, Santa Clara, CA (US)

(21) Appl. No.: 18/749,297

(22) Filed: Jun. 20, 2024

Related U.S. Application Data
(60) Provisional application No. 63/567,390, filed on Mar. 19, 2024.

(51) Int. Cl. G01N 21/27; G01N 21/3504; G01N 21/359

(52) U.S. Cl. CPC G01N 21/274; G01N 21/3504; G01N 21/359

(57) ABSTRACT

In embodiments disclosed herein, a method for calibrating a photonic sensor includes collecting a plurality of concentration measurements with a photonic sensor with a plurality of different reference gas mixtures under various temperature and pressure environments, where each reference gas mixture includes a known species concentration, and implementing a parameter optimization routine to minimize deviations between the known species concentrations and the plurality of concentration measurements obtained by the photonic sensor, where the optimization routine generates one or more calibration constants. In an embodiment, the method may further include integrating the one or more calibration constants into a modified concentration formula, and storing the modified concentration formula in a controller used to operate the photonic sensor.

### CROSS-REFERENCE TO RELATED APPLICATIONS

This application claims the benefit of U.S. Provisional Application No. 63/567,390, filed on Mar. 19, 2024, the entire contents of which are hereby incorporated by reference herein.

### BACKGROUND

### 1) Field

Embodiments of the present disclosure pertain to the field of process monitoring to enable response linearization of photonic sensor outputs.

### 2) Description of Related Art

The fabrication of microelectronic devices, display devices, micro-electromechanical systems (MEMS), and the like require the use of one or more processing chambers. For example, processing chambers such as, but not limited to, an atomic layer deposition (ALD) chamber, a plasma enhanced chemical vapor deposition chamber, a physical vapor deposition chamber, or a plasma treatment chamber may be used to fabricate various devices. As scaling continues to drive to smaller critical dimensions in such devices, the need for uniform processing conditions (e.g., uniformity across a single substrate, uniformity between different lots of substrates, and uniformity between chambers in a facility) as well as process stability during the process are becoming more critical in high volume manufacturing (HVM) environments.

Processing non-uniformity and non-stability arise from many different sources. One such source is the species concentration variability of vaporized precursors. For example, as substrates are processed in a chamber, the precursor source dosage tends to drift in response to many different factors. In some instances, a photonic sensor is used to monitor the concentration of species within a gas that are flown into the chamber and provide control to keep the concentration of the species within a certain window. However, photonic sensors are susceptible to drift as a result of multiple environmental factors. Particularly, photonic sensors are calibrated for a specific temperature and pressure range, which is generally a narrow range. When the operational temperature or pressure goes outside of that narrow range, the sensor readout and the actual species concentration start to deviate. This leads the photonic sensor to have poor accuracy.

### SUMMARY

In embodiments disclosed herein, a method for calibrating a photonic sensor includes collecting a plurality of concentration measurements with a photonic sensor with a plurality of different reference gas mixtures, where each reference gas mixture includes a known species concentration, and implementing a parameter optimization routine to minimize deviations between the known species concentrations and the plurality of concentration measurements obtained by the photonic sensor, where the optimization routine generates one or more calibration constants. In an embodiment, the method may further include integrating the one or more calibration constants into a modified concentration formula, and storing the modified concentration formula in a controller used to operate the photonic sensor.

Embodiments disclosed herein may include a sensor apparatus that includes a gas cell-body with a first end and a second end, and a light source coupled to the first end of the gas cell-body, where the light source is configured to propagate electromagnetic radiation through the gas cell-body. In an embodiment, the sensor apparatus further comprises a photonic detector coupled to the second end of the gas cell-body, and a controller coupled to the photonic detector. In an embodiment, a processor of the controller is configured to convert intensity signals from the photonic detector into species concentrations through the use of a modified concentration formula. In an embodiment, a housing is around the gas cell-body and is temperature controlled. The photonic detector may be outside the housing. In an embodiment, a temperature sensor is configured to measure a temperature of gas that flows through the gas cell-body, and a pressure sensor is configured to measure a pressure within the gas cell-body.

Embodiments disclosed herein may include a method of measuring a concentration of a species in a gas that includes flowing a gas from an ampoule to a chamber, and measuring an intensity signal of a species in the gas with a photonic sensor between the ampoule and the chamber. In an embodiment, the method further includes converting the intensity signal into a concentration of the species through the application of a modified concentration formula that includes one or more calibration constants.

### BRIEF DESCRIPTION OF THE DRAWINGS

FIG. 1 is a schematic illustration of an ampoule for holding a volatile precursor, in accordance with an embodiment of the present disclosure.

FIG. 2 is a plot of absorbance as a function of time for a single pulse of gas passing through a photonic sensor, in accordance with an embodiment of the present disclosure.

FIG. 3 is a plot of on-film performance as a function of time for a constant ampoule temperature, in accordance with an embodiment of the present disclosure.

FIG. 4 is a plot of on-film performance as a function of time for an increasing or upward ramping ampoule temperature, in accordance with an embodiment of the present disclosure.

FIG. 5A is a plot of signal magnitude over time through a plurality of pulses, in accordance with an embodiment of the present disclosure.

FIG. 5B is a plot of the absorbance over the same time as shown in FIG. 5A, in accordance with an embodiment of the present disclosure.

FIG. 6A is a schematic illustration of a photonic sensor, in accordance with an embodiment of the present disclosure.

FIG. 6B is a plot of chemical concentration relative to an intensity of a reference signal, in accordance with an embodiment of the present disclosure.

FIG. 7 is a schematic illustration of a photonic sensor, in accordance with an embodiment of the present disclosure.

FIG. 8 is a schematic illustration of a photonic sensor with an integrated temperature sensor for enabling dynamic correction for leakage current and/or background radiation, in accordance with an embodiment of the present disclosure.

FIG. 9A is a plot of a best fit line for a plurality of calibration measurements for a photonic sensor, in accordance with an embodiment of the present disclosure.

FIG. 9B is a plot of a linear best fit line for a plurality of calibration measurements after a modified concentration formula, that uses a modified Beer-Lambert law, is applied to the photonic sensor signal, in accordance with an embodiment of the present disclosure.

FIG. 10 is a process flow diagram of a process for generating a modified concentration formula that improves the operational temperature range of a photonic sensor, in accordance with an embodiment of the present disclosure.

FIG. 11 is a process flow diagram of a process for measuring a concentration of a species in a gas with a photonic sensor that applies a modified Beer-Lambert formula for improved accuracy, in accordance with an embodiment of the present disclosure.

FIG. 12 illustrates a block diagram of an exemplary computer system of a processing tool, in accordance with an embodiment of the present disclosure.

### DETAILED DESCRIPTION

Photonic sensors used in conjunction with a modified concentration formula based on the Beer-Lambert law configured to precisely and accurately measure the concentration of chemicals, while increasing the operational temperature, pressure, and concentration range of the photonic sensors are described. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

In semiconductor processing (e.g., deposition processes, etching processes, etc.) photonic sensors may be used in order to determine a concentration of a species of gas that is flown into the chamber. In some instances, the species that is delivered to the chamber is combined with a carrier gas before flowing into the chamber. In order to provide highly repeatable and uniform processing (e.g., uniform deposition rates or uniform etch rates), the concentration of the species should be known and precisely controlled.

However, as noted above, most photonic sensors have a non-linear response for given inputs due to various environmental and sensing conditions. That is, for an optimized photonic sensor, the sensor response is expected to have a one-to-one relationship with a reference concentration (i.e., a gas with a known concentration). For example, if a gas has a species concentration of 3.2%, then the output of the photonic sensor should also read 3.2%. However, the responses of most existing photonic sensors do not generally exhibit such a one-to-one relationship. Some sources of non-linearity in photonic sensors include un-collimated photonic beams, multiple scattering of photons, and non-linear pressure and temperature responses.

After calibration of the photonic sensor, the photonic sensor is restricted to use within a narrow temperature range. In applications where the temperature range exceed a linear region of the response, operation of the photonic sensor relies on an extensive lookup database. Accordingly, the results of the photonic sensor relies heavily on interpolation. This causes the calibration process to be an expensive and time consuming operation since a large parameter space needs to be covered to reliably map the operational range of the sensors. Interpolation from a large lookup database may require a significant amount of computation power. In some instances, the computation requirements may exceed those realistically available to the system. Even if the necessary computational power is provided, the speed of executing the computations may not allow for real-time or near real-time calculations. Accordingly, such processes are not suitable for semiconductor processing environments where high precision and near instant control is necessary to obtain uniform processing results within the processing chamber. Some alternative solutions to correct for the non-linear response involve the use of electronic components. However, this introduces more elements to the system (which increases cost and complexity). Also, the additional elements introduce more points of failure for the photonic sensor.

Accordingly, embodiments disclosed herein may include a photonic sensor that is calibrated through a parameter optimization approach. In such an embodiment, the parameter optimization is used to generate one or more constants that can be applied to the typical Beer-Lambert formula. These constants may include coefficients and/or exponents that are added to relevant variables (e.g., temperature, pressure, or the like). The modified concentration formula based on the Beer-Lambert law allows for the conversion of a non-linear response into a linear response with a one-to-one relationship between the photonic sensor signal and the species concentration.

The use of such a modified concentration formula allows for a significant increase in the operational temperature and pressure range of the photonic sensor. This allows for implementation in multiple environmental conditions, or in an environment with changing environmental conditions. Also, such a modification to the operation of the photonic sensor provides improved accuracy in the result. For example, existing solutions may have deviations up to approximately 1%, whereas embodiments disclosed herein may have deviations of up to 0.05%, up to 0.02%, or up to 0.015% based on the adopted model on which the parameter optimization is performed. Improvements in the accuracy may be made by providing a more complex modification of the concentration formula (e.g., through the inclusion of more terms, more coefficients, more exponents, etc.). Accordingly, parameter optimization may improve output reliability by a factor of ten or more.

Further, since the adjustment is to a single formula, the use of embodiments disclosed herein require minimal computational power, especially compared to the use of lookup databases. As such, the adjustment may be implemented directly on the photonic sensor. That is, the modified concentration formula may be stored in a memory that is accessible to a controller of the photonic sensor (in one or more of software, firmware, or hardware). For example, the controller may reside on a board (such as a printed circuit board (PCB)) that is coupled to the photonic detector of the photonic detector system. Though, the controller may also be external to the photonic sensor in some embodiments.

Since the computational power requirements are decreased, the calculation can be made faster. This allows for real-time or near-real time measurement readings. Therefore, such embodiments are great candidates for applications such as semiconductor processing, where continuous control and monitoring of species concentration is used to provide uniform processing results within the processing chamber.

In an embodiment, the photonic sensor may include any type of sensor capable of monitoring the concentration of a species within a gas that is flown through the photonic sensor. In a particular embodiment, the photonic sensor is a non-dispersive infrared (NDIR) optical absorption sensor. Suitable high sensitivity NDIR sensors may be enabled by an actively cooled, passively cooled, or uncooled HgCdTe (MCT) detector that is coupled with a thermally isolated gas cell-body. Embodiments may also be applicable to non-dispersive ultraviolet (NDUV) optical absorption sensors or optical absorption sensors with any wavelength of electromagnetic radiation from UV to IR.

Particularly, the photonic sensor may include a photon (light) source (e.g., an infrared (IR) light source or any other suitable photon source) and a photo-detector. As the gas flows through a gas cell-body of the photonic sensor, electromagnetic radiation (e.g., IR radiation) from the light source is absorbed by the species within the gas. That is, a higher concentration of the species will result in a decrease in the amount of light that reaches the photo-detector. Changes to the magnitude of the intensity signal detected by the photonic detector can be correlated to a concentration of the species through the Beer-Lambert Law using Equation 1.

$$C = m \frac{T}{P} [ {log}_{10} ( \frac{ϕ}{{ϕ}_{0}} ) ] = m \frac{T}{P} Ψ \qquad Equation 1$$

In Equation 1, C is the concentration, m is a constant specific to the measurement system, T is the temperature of the gas, P is the pressure, ϕ is the photon intensity with a species within the gas cell-body, ϕ₀ is the photon intensity without the species inside the gas cell-body, and Ψ is the absorbance. That is, the optical signal (which is correlated to the absorbance Ψ) can be converted to a concentration C of the species.

Advantages or improvements for implementing embodiments described herein can include one or more of (1) improved operational temperature range for the photonic sensor; (2) improved operational concentration range; (3) improved operational pressure range; (4) improved accuracy and/or output reliability of the concentration measurements; (5) real-time or near real-time operation; or (6) simplification of the structure and operation of the photonic sensor.

To provide context, rates of thin-film processes and some etching processes are correlated with precursor concentrations delivered to reactors. Typically, delivered concentration is only inferred from on-wafer thickness or other indirect measurements. Existing sensors suffer from poor signal to noise ratio (SNR), unable to differentiate changes in process conditions or drift. Processes can benefit from a more sensitive photonic sensor that can operate at the low pressures, high temperatures, and low concentrations (<1 mol %) typical of semiconductor processes.

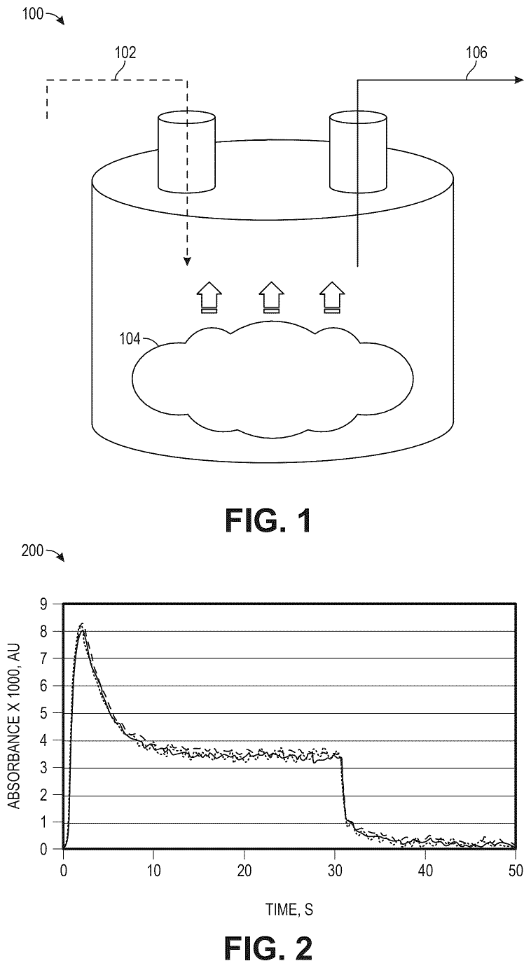

As can be appreciated, low-volatility chemical precursors have complex delivery characteristics. FIG. 1 illustrates a schematic of an ampoule for holding a volatile precursor, in accordance with an embodiment of the present disclosure.

Referring now to FIG. 1, an ampoule 100 includes a carrier gas inlet 102, a storage area for a volatile precursor 104, and a carrier gas/precursor outlet 106. As a carrier gas is flown into the ampoule 100 through the carrier gas inlet 102, the volatile precursor 104 is mixed and “carried” with the carrier gas out of the gas/precursor outlet 106. It is to be appreciated that the amount of the volatile precursor 104 that is removed from the ampoule 100 is dependent on many factors, such as, but not limited to, the flow rate of the carrier gas and/or a temperature of the ampoule 100. For example, heating the ampoule 100 with a heater (not shown) may increase the concentration of volatized precursor 104 in order to allow for a higher concentration of the precursor gas species in the carrier gas/precursor mixture that exits the outlet 106 towards a photonic sensor and a processing chamber.

Referring now to FIG. 2 a plot 200 of absorbance as a function of time, is shown, in accordance with an embodiment. Plot 200 depicts an individual pulse of the carrier gas/precursor mixture exiting the outlet 106. As shown, the concentration varies as a function of time due to the physics of the mass transport. That is, the vapor of the volatile precursor 104 builds up in a closed system before the pulse begins. When the pulse starts, the absorbance is high due to higher concentrations of the volatile precursor 104 The complex dynamics of injecting a dry gas (i.e., the carrier gas) and continuous exhaustion through the ampoule outlet 106 can result in a decreasing concentration of the precursor species that eventually levels off over the remaining duration of the pulse.

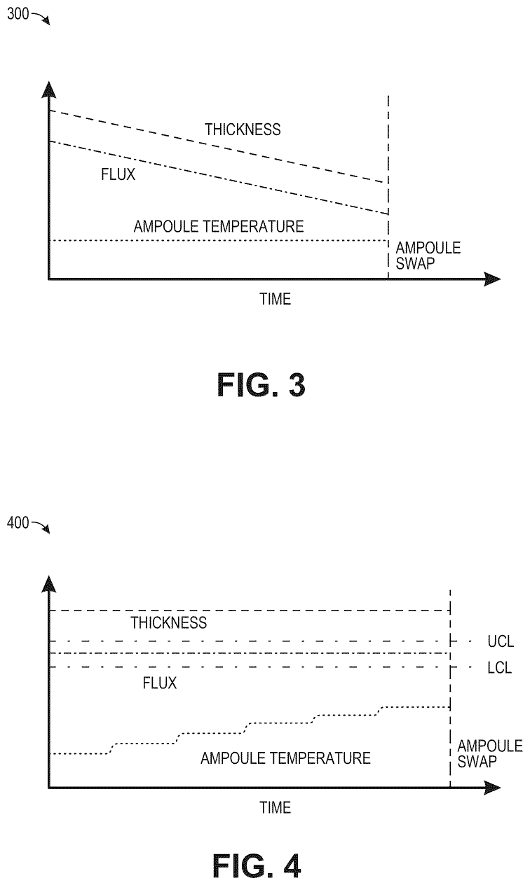

FIG. 3 is a plot 300 of on-film performance as a function of time for a constant ampoule temperature, in accordance with an embodiment.

Particularly, FIG. 3 shows a plot of long-term performance changes, where the dose (sum total of mass injected to the chamber) decreases as the output from the ampoule 100 changes due to many factors. For example, as the liquid or solid volume of the precursor 104 decreases over time, the concentration of the precursor vapor provided to the chamber decreases with all other variables held substantially constant. As a result the deposition rate (e.g., thickness) decreases over time along with the decreasing flux of the precursor 104 provided to the chamber. At a certain point, the deposition rate falls out of specification, and the ampoule 100 will be swapped out for a new ampoule 100.

Processing efficiency can demand improved productivity, improved yield, and improved ampoule utilization (e.g., precursor availability optimization). FIG. 4 is a plot 400 of on-film performance as a function of time for an increasing or upward ramping ampoule 100 temperature, in accordance with an embodiment. The temperature increase compensates for the depletion of the precursor 104 within the ampoule 100. Accordingly, the thickness remains substantially constant, and the flux remains between a lower control limit (LCL) and an upper control limit (UCL).

However, it is to be appreciated that the plot 400 is idealized. That is, the temperature increases to the ampoule 100 provide a near perfect response to the flux of the precursor into the processing chamber. This relies on a very high precision reading of the precursor concentration by the photonic sensor in order to determine what temperature the ampoule 100 needs to be set at. However, as described above, existing photonic sensors may not provide this level of accuracy. The limited accuracy may be due, at least in part, to the linearity of the sensor response relative to the concentration of the species, especially when the photonic sensor is operated over a large temperature and/or pressure range.

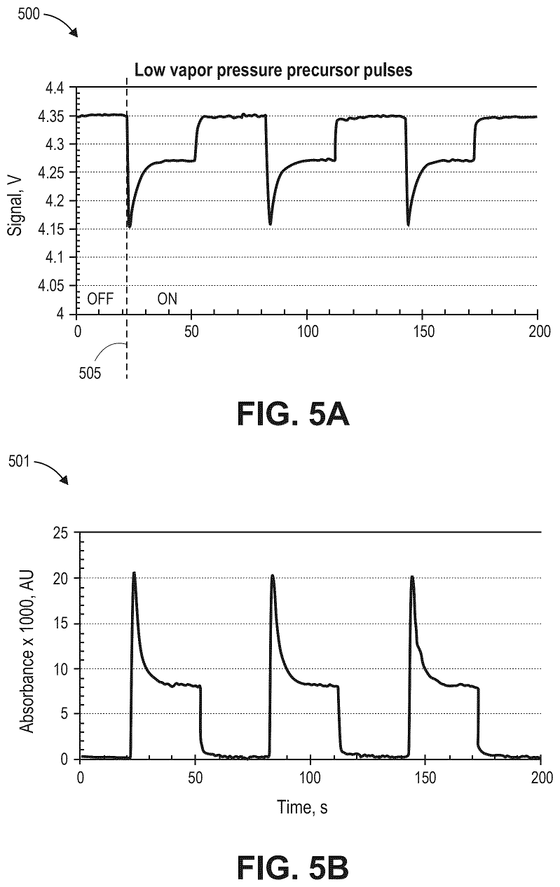

Referring now to FIGS. 5A and 5B, a plot 500 of the intensity signal over time and a plot 501 of the calculated absorbance are shown, in accordance with an embodiment. As shown, the signal is relatively high and constant during an “off” condition (e.g., before line 505), and a rapid decrease in signal is seen at the start of an “on” condition (e.g., after line 505). The on condition (i.e., the pulse length) continues until approximately 50 seconds. Over the duration of the pulse, the value of the intensity signal increases until it plateaus approximately ten seconds into the pulse. At the end of the pulse, the signal increases back to the level of the “off” condition from the start of the cycle. Similarly, the calculated absorbance is at 0 until the start of the pulse. The absorbance has a rapid increase until plateauing before the end of the pulse. The total flux (or dose) can be determined by integrating the pulsed curve over the duration of the pulses. It is to be appreciated that the specific pulse durations and periods between pulses are exemplary in nature. For example, pulse durations may be up to 60 seconds, up to 30 seconds, up to 10 seconds, up to 1.0 second, or up to 0.5 seconds. Though, embodiments may include pulses of any duration in order to achieve a desired processing result on a substrate within a chamber.

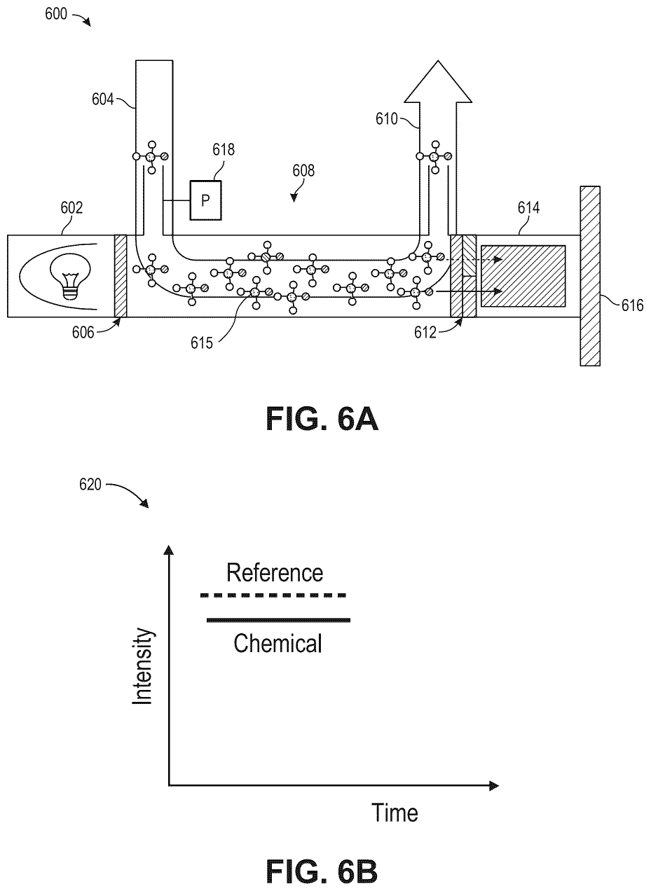

In an embodiment, NDIR optical absorption can be implemented to perform vapor concentration sensing. That is, a concentration of a precursor species in a gas may be calculated through the use of an NDIR sensor. FIG. 6A provides a schematic illustration of such an NDIR system, in accordance with an embodiment.

Referring to FIG. 6A, an NDIR sensor 600 is shown, in accordance with an embodiment. In an embodiment, the NDIR sensor 600 comprises a photon source 602. For example, the photon source 602 may comprise an IR light source, an ultraviolet (UV) light source, or any other suitable source of electromagnetic radiation. A reflector may direct a greater portion of the IR radiation through the NDIR sensor 600. In an embodiment, the IR radiation may propagate along a gas cell-body 608. The gas cell-body 608 may be a hollow tube in some embodiments. The photon source 602 may be separated from the main gas flow path of the gas cell-body 608 by one or both of a window 606 or an optical filter. In some embodiments, the photon source 602 may be spaced away from the gas cell-body 608 and a fiber optic cable and/or other optics may optically couple the light source 602 to the gas cell-body 608. In an embodiment, a photonic detector system may be provided at an opposite end of the gas cell-body 608 from the light source 602. The photonic detector system may comprise an optical filter 612 and a photo-detector 614 after the optical filter 612. For example, the photo-detector 614 may be an IR photo-detector 614 (in the case an IR light source 602 is used), a UV photo-detector 614 (in the case a UV light source 602 is used), or a photo-detector 614 for other wavelengths (in the case any other wavelength light source 602 is used). In an embodiment, a printed circuit board (PCB) 616 may also be part of the photonic detector system. The PCB 616 may house a controller that comprises processing components, memory components, communication components, and/or the like. As will be described in greater detail below, the controller may implement dynamic correction processes in order to improve the performance and/or accuracy of the NDIR sensor 600. In an embodiment, the photonic detector system may also comprise a heatsink (not shown) that is thermally coupled to the photo-detector 614. While the photo-detector 614 is directly adjacent to the gas cell-body 608 in FIG. 6A, it is to be appreciated that optics lines (e.g., optical fibers, lenses, etc.) may be coupled to the gas cell-body 608 (or the filter 612) in order to transport the IR radiation to a photo-detector 614 that is spaced away from the gas cell-body 608. This may be beneficial for thermal control purposes, since the gas cell-body 608 is typically heated, and the photo-detector 614 is temperature sensitive.

In an embodiment an input 604 may be provided proximate to a first end of the gas cell-body 608, and an output 610 may be provided proximate to a second end of the gas cell-body 608. Gas that comprises species 615 (e.g., a precursor species) may flow into the gas cell-body 608 through the input 604, travel along a length of the gas cell-body 608, and exit the NDIR sensor 600 through the output 610. As the IR radiation propagates along the gas cell-body 608, the species 615 may absorb some of the IR radiation. This decreases the magnitude of the signal detected by the photo-detector 614. As described above, the change in magnitude of the signal can be used to determine a concentration of the species 615. In some embodiments, a pressure sensor 618 or pressure transducer may be coupled to one or more of the input 604, the gas cell-body 608, or the output 610.

Referring now to FIG. 6B, a plot 620 showing an idealized relationship between the reference signal (dashed line) and the chemical concentration (solid line) is shown. As illustrated, the reference signal has the same slope as the chemical concentration. In some instances, the two lines may be on top of each other. However, as shown in FIG. 6B, there may be some constant offset between the two lines that may occur when there is no calibration or correction such as will be described in greater detail herein.

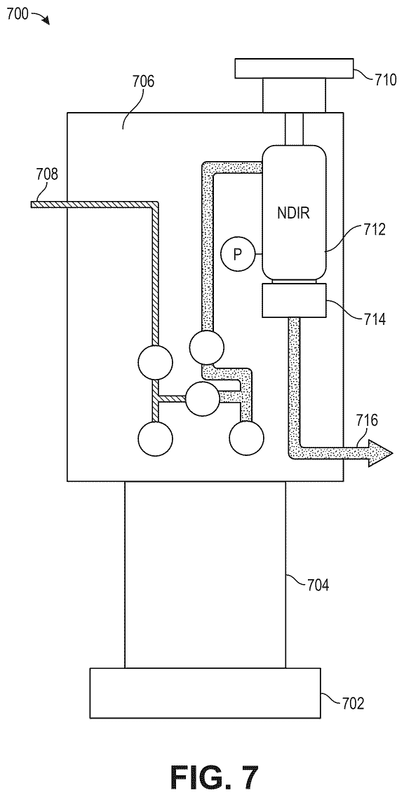

Referring now to FIG. 7, a schematic illustration of a photonic sensor 700, such as an NDIR sensor, is shown, in accordance with an embodiment. As shown, the photonic sensor 700 may comprise an input 708 that feeds a gas (with a precursor species) into a gas cell-body 712. A light source 714 may emit IR radiation through the gas cell-body 712 towards a photo-detector 710 at an opposite end of the gas cell-body 712. An outlet 716 may allow for gas to leave the photonic sensor 700.

In an embodiment, a housing 706 may be provided around the gas cell-body 712. The housing 706 may sometimes be referred to as a hot can. That is, the housing 706 may be a temperature controlled housing 706. For example, a bottom heater 702 and a side heater 704 may heat the housing 706 in some embodiments. In other embodiments, the bottom heater 702 may be positioned on the ampoule (not shown) in order to control a temperature of the ampoule. Further, while shown as contacting the bottom of the housing 706, one or both of the heaters 702 and 704 may wrap around (or partially around) an outer perimeter of the housing 706. The heating may be used to provide a near constant temperature for the gas cell-body 712 in order to improve accuracy of the photonic sensor 700. Since excess heat degrades the accuracy of the photo-detector 710, the photo-detector 710 may be provided outside of the housing 706.

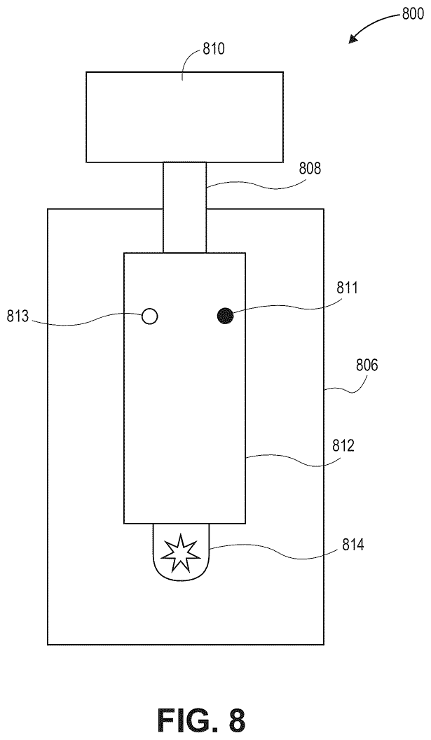

In order to implement the modified concentration formula disclosed herein, sensors for values such as temperature of the gas with the gas cell-body 712 and a pressure within the gas cell-body 712 may be needed. An example of a photonic sensor with such additional sensors is shown, in accordance with FIG. 8.

Referring now to FIG. 8, a schematic illustration of a photonic sensor 800 is shown, in accordance with an embodiment. In an embodiment, the photonic sensor 800 may be an NDIR sensor or the like. The photonic sensor 800 may comprise a light source 814, such as an IR light source. The light source 814 may be similar to any of the photon sources described in greater detail herein. The photon source 814 may be coupled to a gas cell-body 812 so that the IR radiation propagates along a length of the gas cell-body 812 towards a photonic detector system 810. A connector 808 may couple the gas cell-body 812 to the photonic detector system 810 so that the photonic detector system 810 can be positioned outside of a temperature controlled housing 806 (e.g., a hot can). In an embodiment, the photonic detector system 810 may comprise a photo-detector, a controller, and a heat sink. The photonic detector system 810 may be similar to any of the photonic detector systems described in greater detail herein.

In an embodiment, the photonic sensor 800 may further comprise a temperature sensor 811 that is configured to measure a temperature of gas within the gas cell-body 812, and a pressure sensor 813 that is configured to measure a pressure within the gas cell-body 812. The temperature sensor 811 may be inserted through a port in the gas cell-body 812 in order to reach the gas within the gas cell-body 812. In other embodiments, the temperature sensor 811 may be directly contacting an outer surface of the gas cell-body 812, and the temperature of the gas can be determined through heat transfer equations. In an embodiment, the temperature sensor 811 may include any suitable type of temperature sensor. For example, the temperature sensor 811 may comprise a resistance temperature detector (RTD), a thermocouple, or the like. The pressure sensor 813 may be provided through a port in the gas cell-body 812. Alternatively, a pipe (not shown) may fluidically couple the pressure sensor 813 to an interior of the gas cell-body 812. In an embodiment, the pressure sensor 813 may include any suitable type of pressure sensor. A pressure transducer may also be used instead of a pressure sensor 813 in some embodiments.

In an embodiment, the temperature sensor 811 and the pressure sensor 813 may be used in order to provide input values for the Beer-Lambert formula used to convert an intensity signal into a species concentration. However, as noted above, operation of the photonic sensor 800 over large temperature ranges can provide significant deviations between the relationship between the intensity signal and the species concentration. As such, solely relying on the standard Beer-Lambert formula may not be sufficient for some high precision applications, such as those used in semiconductor manufacturing environments for deposition or etching processes.

Accordingly, embodiments disclosed herein provide a calibration process that is used to generate a modified Beer-Lambert formula that linearizes the relationship between the measured species concentration and a reference species concentration.

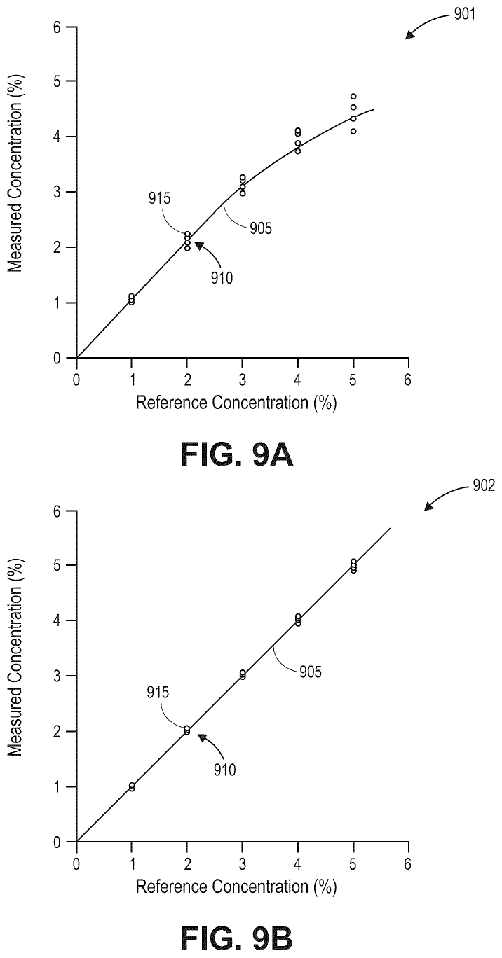

Referring now to FIGS. 9A and 9B, plots 901 and 902 illustrate the benefits provided by implementing a parameter optimization routine are shown, in accordance with an embodiment. As shown in plot 901 of FIG. 9A, the best fit line 905 for the calibration process is non-linear line 905. In contrast, the plot 902 of FIG. 9B (which has undergone a parameter optimization routine) is linear line 905 with a one-to-one relationship between the measured concentration and the reference concentration.

In the plots 901 and 902, reference gasses with known concentrations (i.e., the reference concentration) are measured by a photonic sensor (i.e., the measured concentration). Each reference gas (e.g., 1%, 2%, 3%, 4%, and 5%) is measured at a plurality of different temperature and pressure combinations. Each point 915 represents one of those temperature and pressure combinations. The sets 910 represent the group of points 915 with the same reference concentration. As shown, the points 915 within a set 910 are closely packaged at lower concentrations and spread out at higher concentrations. However, for the parameter optimized result in FIG. 9B, even the high concentration sets are closely positioned to the best fit line 905. In an embodiment, such tightly clustered sets 910 leads to excellent R² values. For example, R² values of optimized systems disclosed herein may be approximately 0.9995 or higher.

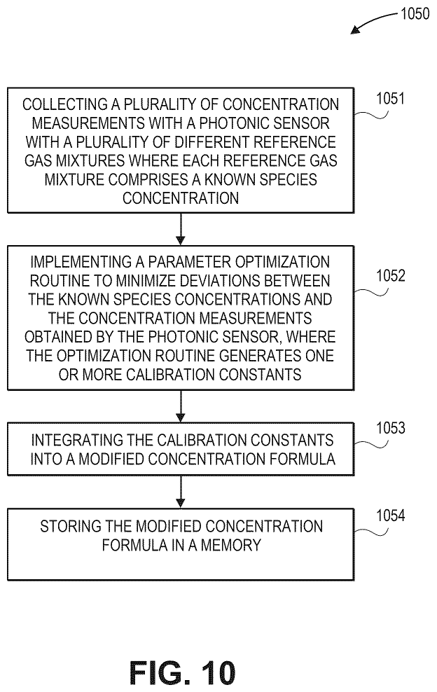

Referring now to FIG. 10, a process flow diagram of a process 1050 for calibrating a sensor with a parameter optimization routine is shown, in accordance with an embodiment. In an embodiment, the process 1050 may begin with operation 1051, which comprises collecting a plurality of concentration measurements with a photonic sensor (such as an NDIR sensor or any other photonic sensor described herein) with a plurality of different reference gas mixtures. In an embodiment, each reference gas mixture comprises a known species concentration. In an embodiment, the gas mixtures may include species concentrations of between 1% and 20%. Though, smaller or larger species concentrations may also be used in some embodiments.

In an embodiment, multiple concentration measurements may be made for each species concentration. For example, each concentration measurement may include a specific species concentration at a desired pressure (within the gas cell-body) and temperature of the reference gas mixture. For example, each species concentration may be measured up to five times (with five different temperature and pressure pairs), up to ten times (with ten different temperature and pressure pairs), or up to twenty or more times (with twenty or more different temperature and pressure pairs). In an embodiment the temperature range may be between 20° C. and 120° C., and the pressure range may be between 50 Torr and 150 Torr. Though, it is to be appreciated that calibration processes described herein may allow for even greater temperature ranges and pressure ranges.

In an embodiment, the process 1050 may continue with operation 1052, which comprises implementing a parameter optimization routine to minimize deviations between the known species concentrations and the plurality of concentration measurements obtained by the photonic sensor. In an embodiment, the optimization routine generates one or more calibration constants. In an embodiment, the parameter optimization routine may include a Chi-square minimization, or any other suitable minimization process. In an embodiment, the one or more calibration constants may comprise one or more of a coefficient or an exponent for the concentration formula. Additional terms may also be added to the concentration formula. In an embodiment, modified Beer-Lambert law provides a linearization of a relationship between the concentration measurements and the known species concentration. For example, the relationship is approximately 1:1.

In an embodiment, the process 1050 may continue with operation 1053, which comprises integrated the one or more calibration constants into a modified Beer-Lambert formula. In an embodiment, increasing the complexity may provide a more accurate linearization of the response. This can lead to reductions in the deviation percentage. For example deviations percentages up to 0.05%, up to 0.02%, or up to 0.015% may be obtainable in some embodiments. Accordingly, parameter optimization may improve output reliability by a factor of ten or more compared to a deviation of around 0.5% that is typical of existing photonic sensors.

In an embodiment, examples of modified concentration calculation formula based on the Beer-Lambert law are shown in Equations 2-4.

$$C = m \frac{T}{{P}^{n}} Ψ \qquad Equation 2$$

In Equation 2, C is the species concentration, m is a constant specific to the measurement system, T is the temperature of the gas, P is the pressure within the gas cell-body, n is an exponential calibration constant, and Ψ is the absorbance. In an embodiment, the parameter optimization may be used to adjust the m coefficient and the n exponent in order to improve the linearity of the response (i.e., by bringing the relationship between the concentration measurements and the known species concentration closer to one-to-one). For example, providing an n exponent can modify the weight given to the pressure variable.

In an embodiment, a more complex and accurate modified concentration calculation formula based on the Beer-Lambert law is provided in Equation 3.

$$C = m \frac{{T}^{n}}{{P}^{p}} {Ψ}^{q} \qquad Equation 3$$

In Equation 3, the parameter optimization may be used to adjust the m coefficient, the n exponent, the p exponent, and the q exponent in order to improve the linearity of the response (i.e., by bringing the relationship between the concentration measurements and the known species concentration closer to one-to-one). For example, providing an n exponent can modify the weight given to the temperature variable, providing a p exponent can modify the weight given to the pressure variable, and providing a q exponent can modify the weight given to the absorbance.

In an embodiment, an even more complex and accurate modified concentration calculation formula based on the Beer-Lambert law is provided in Equation 4.

$$C = \frac{{T}^{m}}{{P}^{n}} [ p {Ψ}^{2} + q Ψ ] \qquad Equation 4$$

In Equation 3, an extra term pΨ² is added to the modified concentration calculation formula based on the Beer-Lambert law in order to provide increased flexibility to adjust the optimization. For example, the extra term may be a parabolic or other exponential function. In an embodiment, the parameter optimization may be used to adjust the m exponent, the n exponent, the p coefficient, and the q coefficient in order to improve the linearity of the response (i.e., by bringing the relationship between the concentration measurements and the known species concentration closer to one-to-one). For example, providing an m exponent can modify the weight given to the temperature variable, providing an n exponent can modify the weight given to the pressure variable, providing a p coefficient can modify the weight given to the additional exponential absorbance term, and providing a q coefficient can modify the weight given to the absorbance.

In Equations 2-4, several examples of modified concentration calculation formulas based on the Beer-Lambert law are provided with increasing complexity in order to more accurately map the measured species concentration to the references species concentration (with Equation 3 being more accurate than Equation 2, and Equation 4 being more accurate than Equation 3). Though, it is to be appreciated that alternative formats for the modified Beer-Lambert formula may be used in other embodiments. Particularly, the optimization process is used to find the values for each calibration constant the reduces the deviation across all measurements.

In the process 1050, operations 1052 and 1053 are described as distinct operations that are sequentially implemented. However, embodiments may include a process where one or more aspects of operation 1052 and one or more aspects of operation 1053 are implemented in unison. Additionally, one or more aspects of operation 1053 may be implemented before one or more aspects of operation 1052. For example, the form of the modified Beer-Lambert formula may be set first, and the parameter optimization routine may be done to determine the values of the calibration constants that minimize the error in the system.

In an embodiment, the process 1050 may continue with operation 1054, which comprises storing the modified Beer-Lambert formula in a memory. In an embodiment, the memory is accessible to a controller that may be used to operate the photonic sensor. In an embodiment, the modified Beer-Lambert formula may be stored in one or more of software, firmware, or hardware. For example, the controller may reside on a board (e.g., a PCB) that is coupled to the photonic detector of the photonic detector system. Though, the controller may also be external to the photonic sensor in some embodiments.

As can be appreciated, the photonic sensor now has easy access to the modified Beer-Lambert formula for use during operation of the photonic sensor. Since the conversion from the measured intensity signal to species concentration is made through the application of a single formula, the computing resources that are necessary are minimal. This allows for fast (e.g., real-time or near real-time) generation of species concentration values that can be used to control species flux or dose to a processing chamber.

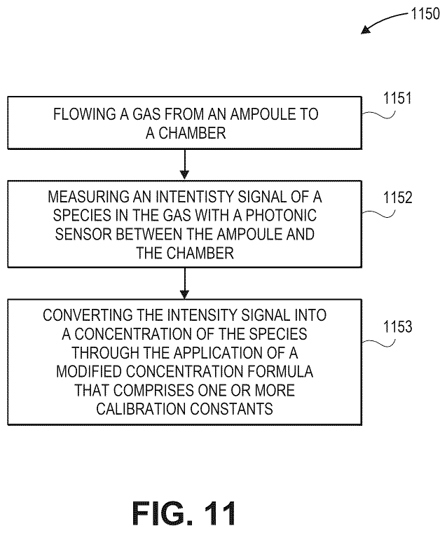

Referring now to FIG. 11, a process 1150 for measuring a concentration of a species in a gas is shown, in accordance with an embodiment. In an embodiment, the process 1150 may begin with operation 1151, which comprises flowing a gas from an ampoule to a chamber. In an embodiment, the ampoule may be similar to any ampoule described in greater detail herein. The chamber may be an atomic layer deposition (ALD) chamber, a chemical vapor deposition (CVD) chamber, a plasma enhanced ALD (PEALD) chamber, a plasma enhanced CVD (PECVD) chamber, a vapor deposition chamber, a physical vapor deposition (PVD) chamber, or a plasma treatment chamber. The chamber may be used to fabricate various devices, such as semiconductor devices.

In an embodiment, the process 1150 may continue with operation 1152, which comprises measuring an intensity signal of a species in the gas with a photonic sensor between the ampoule and the chamber. In an embodiment, the photonic sensor may be an NDIR sensor or any other type of photonic sensor, such as those described herein.

In an embodiment, the process 1150 may continue with operation 1153, which comprises converting the intensity signal into a concentration of the species through the application of a modified Beer-Lambert formula. In an embodiment, the modified Beer-Lambert formula comprises one or more calibration constants. In an embodiment, the modified Beer-Lambert formula is the result of a parameter optimization routine, such as the one included in process 1050 described above.

In an embodiment, the modified Beer-Lambert formula may be stored in a memory and accessible by one or more of software, firmware, or hardware of a controller communicatively coupled to the photonic sensor. For example, the controller may reside on a board (e.g., a PCB) that is coupled to the photonic detector of the photonic detector system. Though, the controller may also be external to the photonic sensor in some embodiments.

Embodiments disclosed herein explicitly describe process monitoring for flowing gasses into semiconductor processing chambers (e.g., within plasma chambers for deposition processes, etching processes, etc.) However, it is to be appreciated that photonic sensors have applicability to many different monitoring applications. For example, volatile chemicals in the environment, breathing system, aircraft interior air quality/gas concentration and/or the like. That is, photonic sensors calibrated with a parameter optimization process may be used in many different applications.

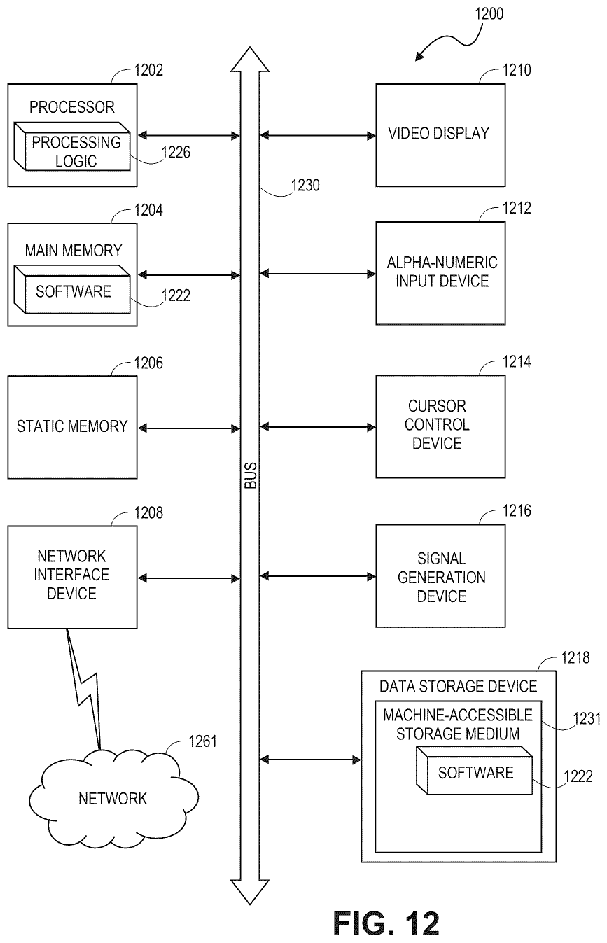

Referring now to FIG. 12, a block diagram of an exemplary computer system 1200 of a processing tool is illustrated in accordance with an embodiment. In an embodiment, computer system 1200 is coupled to and controls processing in the processing tool. The computer system 1200 may be communicatively coupled to one or more vapor concentration sensor modules, such as those disclosed herein. The computer system 1200 may utilize outputs from the one or more vapor concentration sensor modules in order to modify one or more parameters, such as, for example, processing recipe parameters, cleaning schedules for the processing tool, component replacement determinations, and the like.

Computer system 1200 may be connected (e.g., networked) to other machines in a Local Area Network (LAN), an intranet, an extranet, ECAT, or the Internet. Computer system 1200 may operate in the capacity of a server or a client machine in a client-server network environment, or as a peer machine in a peer-to-peer (or distributed) network environment. Computer system 1200 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated for computer system 1200, the term “machine” shall also be taken to include any collection of machines (e.g., computers) that individually or jointly execute a set (or multiple sets) of instructions to perform any one or more of the methodologies described herein.

Computer system 1200 may include a computer program product, or software 1222, having a non-transitory machine-readable medium having stored thereon instructions, which may be used to program computer system 1200 (or other electronic devices) to perform a process according to embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, cloud storage, optical storage media, flash memory devices, etc.), a machine (e.g., computer) readable transmission medium (electrical, optical, acoustical or other form of propagated signals (e.g., infrared signals, digital signals, etc.)), etc.

In an embodiment, computer system 1200 includes a system processor 1202, a main memory 1204 (e.g., read-only memory (ROM), flash memory, dynamic random access memory (DRAM) such as synchronous DRAM (SDRAM) or Rambus DRAM (RDRAM), etc.), a static memory 1206 (e.g., flash memory, static random access memory (SRAM), etc.), and a secondary memory 1218 (e.g., a data storage device), which communicate with each other via a bus 1230.

System processor 1202 represents one or more general-purpose processing devices such as a microsystem processor, central processing unit, or the like. More particularly, the system processor may be a complex instruction set computing (CISC) microsystem processor, reduced instruction set computing (RISC) microsystem processor, very long instruction word (VLIW) microsystem processor, a system processor implementing other instruction sets, or system processors implementing a combination of instruction sets. System processor 1202 may also be one or more special-purpose processing devices such as an application specific integrated circuit (ASIC), a field programmable gate array (FPGA), a digital signal processor (DSP) system, network system processor, or the like. System processor 1202 is configured to execute the processing logic 1226 for performing the operations described herein.

The computer system 1200 may further include a system network interface device 1208 for communicating with other devices or machines. The computer system 1200 may also include a video display unit 1210 (e.g., a liquid crystal display (LCD), a light emitting diode display (LED), or a cathode ray tube (CRT)), an alphanumeric input device 1212 (e.g., a keyboard), a cursor control device 1214 (e.g., a mouse), and a signal generation device 1216 (e.g., a speaker).

The secondary memory 1218 may include a machine-accessible storage medium 1231 (or more specifically a computer-readable storage medium) on which is stored one or more sets of instructions (e.g., software 1222) embodying any one or more of the methodologies or functions described herein. The software 1222 may also reside, completely or at least partially, within the main memory 1204 and/or within the system processor 1202 during execution thereof by the computer system 1200, the main memory 1204 and the system processor 1202 also constituting machine-readable storage media. The software 1222 may further be transmitted or received over a network 1261 via the system network interface device 1208. In an embodiment, the network interface device 1208 may operate using RF coupling, optical coupling, acoustic coupling, or inductive coupling.

While the machine-accessible storage medium 1231 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies. The term “machine-readable storage medium” shall accordingly be taken to include, but not be limited to, solid-state memories, and optical and magnetic media.

Thus, embodiments of the present disclosure include photonic sensors that are calibrated for operation over a large temperature range through the use of a modified Beer-Lambert formula that is generated through a parameter optimization routine.

The above description of illustrated implementations of embodiments of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

What is claimed is:

1. A method for calibrating a photonic sensor, comprising:
collecting a plurality of concentration measurements with the photonic sensor with a plurality of different reference gas mixtures, wherein each reference gas mixture comprises a known species concentration;
implementing a parameter optimization routine to minimize deviations between the known species concentrations and the plurality of concentration measurements obtained by the photonic sensor, wherein the parameter optimization routine generates one or more calibration constants;
integrating the one or more calibration constants into a modified concentration formula; and
storing the modified concentration formula in a memory.

2. The method of claim 1, wherein the parameter optimization routine comprises a Chi-square minimization.

3. The method of claim 1, wherein the one or more calibration constants comprises a coefficient.

4. The method of claim 1, wherein the one or more calibration constants comprise an exponent.

5. The method of claim 1, wherein the modified concentration formula provides a linearization of a relationship between the concentration measurements and the known species concentration.

6. The method of claim 5, wherein the relationship is approximately 1:1 with a deviation of up to 0.05%.

7. The method of claim 6, wherein the deviation is up to 0.02%.

8. The method of claim 1, wherein the plurality of concentration measurements are made over one or more of a temperature range, a concentration range, or a pressure range.

9. The method of claim 8, wherein the temperature range is between 20° C. and 120° C. and the pressure range is between 50 Torr and 150 Torr.

10. The method of claim 1, wherein the photonic sensor is a non-dispersive optical sensor that operates with electromagnetic radiation with a wavelength from ultraviolet (UV) to infrared (IR).

11. An apparatus, comprising:
a gas cell-body with a first end and a second end;
a light source coupled to the first end of the gas cell-body, wherein the light source is configured to propagate electromagnetic radiation through the gas cell-body;
a photonic detector coupled to the second end of the gas cell-body;
a controller coupled to the photonic detector, wherein a processor of the controller is configured to convert intensity signals from the photonic detector into species concentrations through a use of a modified concentration formula;
a housing around the gas cell-body that is temperature controlled, wherein the photonic detector is outside the housing;
a temperature sensor configured to measure a temperature of gas that flows through the gas cell-body; and
a pressure sensor configured to measure a pressure within the gas cell-body.

12. The apparatus of claim 11, wherein the modified concentration formula comprises one or more calibration constants.

13. The apparatus of claim 12, wherein the one or more calibration constants comprise one or both of a coefficient or an exponent.

14. The apparatus of claim 11, wherein the modified concentration formula is stored in the controller as part of one or more of a hardware component, a firmware component, or a software component.

15. The apparatus of claim 11, wherein the photonic detector is an infrared photo-detector or an ultraviolet photo-detector.

16. The apparatus of claim 11, further comprising:
an inlet proximate to the first end the gas cell-body for flowing the gas into the gas cell-body, wherein the inlet is fluidically coupled to an ampoule; and
an outlet proximate to the second end of the gas cell-body for flowing the gas out of the gas cell-body, wherein the outlet is fluidically coupled to a processing chamber.

17. The apparatus of claim 11, wherein the apparatus is a non-dispersive infrared (NDIR) sensor or a non-dispersive ultraviolet (NDUV) sensor.

18. A method of measuring a concentration of a species in a gas, comprising:
flowing the gas from an ampoule to a chamber;
measuring an intensity signal of the species in the gas with a photonic sensor between the ampoule and the chamber; and
converting the intensity signal into the concentration of the species through an application of a modified concentration formula that comprises one or more calibration constants.

19. The method of claim 18, wherein the photonic sensor is a non-dispersive infrared optical sensor that operates with electromagnetic radiation with a wavelength from infrared (IR) to ultraviolet (UV).

20. The method of claim 18, wherein the modified concentration formula is a result of a parameter optimization.
